(19) United States
(12) Patent Application Publication
(10) Pub. No.: US 2023/0224213 A1
(43) Pub. Date: Jul. 13, 2023

(54) NETWORK SWITCH WITH AUTOMATED PORT PROVISIONING

(71) Applicant: TARGET BRANDS, INC., Minneapolis, MN (US)

(72) Inventors: Bryan CROSSLAND, Minneapolis, MN (US); Edward STOCKWELL, Minneapolis, MN (US); Jeffrey HENNING, Minneapolis, MN (US); William ARGYROS, Minneapolis, MN (US); Edward J. COLLINS, IV, Minneapolis, MN (US); Jeffrey STRANDE, Minneapolis, MN (US)

(21) Appl. No.: 17/575,282

(22) Filed: Jan. 13, 2022

(51) Int. Cl. H04L 41/0806; H04L 45/74; H04L 12/46

(52) U.S. Cl. CPC H04L 41/0806; H04L 45/742; H04L 12/4679

(57) ABSTRACT

In various embodiments systems and methods for managing a network switch, such as for a VLAN is disclosed. In one example, a method includes responsive to a restart of a port of a network switch, obtaining by the network switch a current policy applied to the port, determining based on a parameter associated with the current policy, to apply a default policy to the port, determining a new policy for the port by: obtaining an identifier for a device associated with the port, obtaining a key based on the identifier, the key associated with a plurality of devices of the same type as the device, and determining the new policy for the port using an association between the key and the new policy stored locally at the network switch, and applying the new policy to the port.

### BACKGROUND

Network switches may be used to provide virtual local area networks (VLANs) for a variety of computing devices communicatively connected to the network switch. When a new device is connected to a port of the network switch, the port may be configured to place the new device in the correct VLAN. Configuration of the network switch may be a labor intensive process, involving a network administrator opening a remote connection to the network switch and manually configuring each port of the network switch. Accordingly, connecting new devices to a network switch, initial configuration of a network switch, and/or reconfiguring a network switch after power or network failure may be difficult and time intensive.

### SUMMARY

In one embodiment, one or more non-transitory computer readable media encoded with instructions is disclosed. The instructions when executed by one or more processors of a network switch cause the network switch to detect an event associated with a port of the network switch, determine an identifier for a device associated with the port, obtain a key based on the identifier, the key associated with a device type of the device, determine a policy for the port using an association between the key and the policy stored locally at the network switch, and apply the policy to the port.

In another embodiment, a network switch is disclosed. The network switch includes a memory storing policy and configuration data for ports of the network switch and one or more processors configured to execute instructions causing the processors to: detect an event associated with one of the ports of the network switch, determine an identifier for a device associated with the port, obtain a key based on the identifier, the key associated with a plurality of devices of the same type as the device, determine a policy for the port using the key and the policy and configuration data, and apply the policy to the port.

In yet another embodiment, a method is disclosed. The method includes responsive to a restart of a port of a network switch, obtaining by the network switch a current policy applied to the port, determining based on a parameter associated with the current policy, to apply a default policy to the port, determining a new policy for the port by: obtaining an identifier for a device associated with the port, obtaining a key based on the identifier, the key associated with a plurality of devices of the same type as the device, and determining the new policy for the port using an association between the key and the new policy stored locally at the network switch, and applying the new policy to the port.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example system including a network switch configured to connect network devices, in accordance with various embodiments of the disclosure.

FIG. 2 illustrates an example network switch, in accordance with various embodiments of the disclosure.

FIG. 3 illustrates an example method for configuring a port of a network switch, in accordance with various embodiments of the disclosure.

FIG. 4 illustrates an example method for configuration of a network switch in accordance with various embodiments of the disclosure.

FIG. 5 is a schematic diagram of an example computer system which may be used to implement various embodiments in the examples described herein.

### DETAILED DESCRIPTION

A network switch disclosed herein may include software for automating port provisioning (e.g., network settings) for ports of the network switch. Such automated port provisioning may allow fast and automatic configuration for devices coupled to a network via the network switch. For example, such software can be used to automatically configure port characteristics for point of sale and other devices within a retail location or other multi-device environment, eliminating or substantially reducing time intensive manual setup. In some examples, upon detecting a change in connection status for a port of the network switch (e.g., from a new device being connected to the port), a port manager of the network switch determines whether the port is configured correctly to place the connected device in an appropriate VLAN and if not, updates the port based on determined characteristics for the device type.

In various examples, a port manager of the network switch receives identifying information (e.g., a media access control (MAC) address) for a device connected to a port or other connection of the network switch. The identifying information may be used to query a centralized database to obtain a key for the device. The device key may be used to look up a configuration policy (e.g., association of a VLAN for a device type) for the port. Utilizing the configuration policy, the port may be configured accordingly to place the device on the correct VLAN or otherwise properly couple the device to the network. In some instances, the configuration policies of the ports of the network switch may be stored locally to the network switch such that the network switch may be automatically reconfigured after an event such as a power outage or system failure.

The present system allows automatic and correct coupling of devices to the network and helps to eliminate user error in coupling devices. For example, conventional coupling techniques may require a person to individually connect a device to the network switch, and mistakes with respect to the type of configuration settings, ports, or the like, would prevent the device from being connected properly. Further, upon system outages, such as power loss, or when doing a large scale implementation, such as setting up a new environment for multiple devices, the individual device configuration methods takes a substantial amount of time. The present system allows automatic determination of configuration settings that are specific to a particular device to be coupled. Further, using a centralized database for management of device keys and device identifiers allows for greater scalability than directly mapping device identifiers to policies, allowing ease of implementation across multiple locations and types of devices.

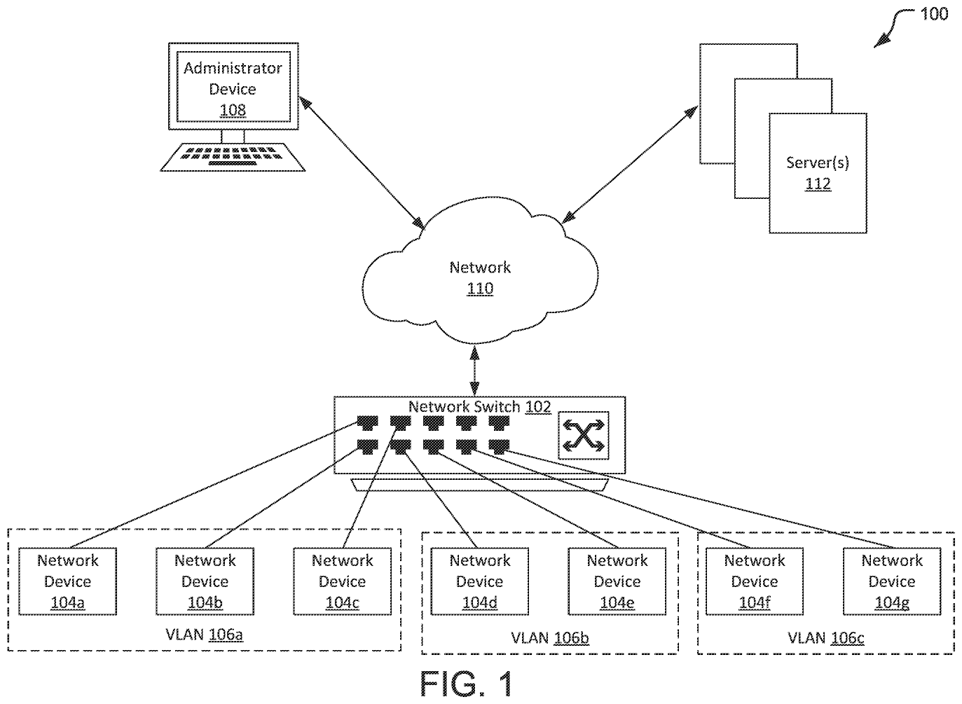

Turning now to the figures, FIG. 1 illustrates an example system 100 including a network switch 102 configured to connect network devices 104a-104g into segmented networks, such as VLANs 106a-106c in accordance with some embodiments of the disclosure. As shown in FIG. 1, the system 100 may include the network switch 102 connected to a network 110 and in communication with one or more servers 112. In some examples, an administrator device 108 and/or other end user devices may also be configured to communicate with the network switch 102 via the network 110.

The network switch 102 may include multiple ports configured to provide access to the network 110 to devices 104a-104g connected to the ports. The ports of the network switch 102 generally direct network traffic to and from network devices connected to the ports. Devices connected to ports of the network switch 102 on the same segmented network (e.g., VLAN) may send and receive data directly between one another without sending data over the network 110. The ports of the network switch 102 may be assigned a policy, which may provide various settings (e.g., security settings, network segmentation, and the like) for a device connected to the port. For example, configuration of the port may affect what network resources a device connected to the port is able to access. In some examples, such policies may be stored locally at the network switch 102, but in other implementations may be stored across the network and retrieved for local use when needed. For example, a mapping of policies currently applied to each port of the network switch 102 may be stored at the network switch 102.

Keys may be mapped to policies, such as port configuration policies. Keys may be used to group similar devices or devices using the same network configuration policies when connected to the network switch. Accordingly, the key mapping may be more compact than a direct mapping of device identifiers to port configuration policies. This key mapping may also be stored locally at the network switch 102, where the keys are based on various device identifiers, and broadly chosen to identify types of devices using the same port configuration to connect to the network switch 102. For example, a key may be associated with a range of MAC addresses belonging to voice over internet protocol (VOIP) phones. A mapping of device identifiers to keys may be stored at one or more servers 112. In some examples, when a new device is connected to a port of the network switch 102, the network switch 102 may determine a device identifier of the device. The network switch 102 may query the server 112 to determine the key and may then utilize the key to determine a policy to apply to the port.

In embodiments where the mapping of device identifiers to keys is stored at a server 112, the mapping may be dynamic and more easily updated as new devices are added to the network switch 102. For example, a device identifier may be mapped to a key representing like devices. The key may be mapped, at the network switch, to a policy for the port. Accordingly, each device does not have to be newly associated with a policy. Additionally, the mapping of keys to policies at the network switch may not need to be updated for a new device identifier. Further, using keys to represent groups of devices results in fewer manual configurations, which may cause errors in configuration of the network switch 102. For example, without a mapping of keys to network devices, each network device may be manually paired with a policy. Mapping each device to a policy may be cumbersome and often results in errors in configuration, especially in large scale systems. Further, several network switches may utilize the same device identifier to key mapping where similar devices are connected to the network switches. For example, network switches in retail locations may connect the same types of devices and may utilize the same mapping of device identifiers to keys at the server 112. This further reduces the amount of manual setup and errors in network configuration, as new network switches in new locations may need less manual configuration.

A port of the network switch 102 may be assigned to (e.g., configured for) communication of data traffic via one or more of the VLANs 106a-106g when a policy is applied to the port. A VLAN is generally a logical construct, creating a separate (e.g., segmented) network available to devices assigned to the VLAN. Accordingly, various settings, such as security settings, can be configured based on the types of devices included in a particular VLAN. For example, a VLAN configured for point of sale devices may use encryption, firewalls, or other security features to protect sensitive information processed by the point of sale devices. Further, segmenting a physical network into several logical networks may improve network speed as each VLAN may be configured for communication of certain types of network traffic. Where a port is assigned to a VLAN 106a, a device connected to the network switch 102 via the port communicates via the VLAN 106a associated with the port. A port of the network switch 102 may be assigned to one VLAN (e.g., a single endpoint port), or may be assigned to multiple VLANs (e.g., a trunked port). A port assigned to several VLANs may use various techniques, such as traffic tagging, to utilize one of the multiple VLANs to communicate data traffic based on, for example, the type of traffic being communicated.

Network devices 104a-104g may include various types of devices connecting to the network 110 and one another via the network switch 102. Such devices may include, for example, point of sale devices (e.g., registers), workstations, environmental controllers (e.g., lighting controllers), alarm systems, phones (e.g., VOIP phones), printers, servers, video monitoring systems, and other devices in a physical location, such as a retail location, business, etc. The network devices 104a-104g may be assigned to VLANs 106a-106c configured based on device type of the network devices 104a-104g when connected to a port of the network switch 102. Each of the network devices 104a-104g may be associated with one or more device identifiers, which may be used by the network switch 102 to determine a policy to apply to a port to which a network device 104a is connected. For example, device identifiers may include MAC addresses, serial numbers, manufacturer identity, or other information correlating to device type.

Generally, the administrator device 108 may be a device belonging to a user, such as a network administrator, to generate configure the network switch 102 and perform other tasks by communicating with the network switch 102 and/or the servers 112. The administrator device 108 may, accordingly, be a computing device with access to at least the network 110. The administrator device 108 may, for example, communicate with the servers 112 to configure and/or update mappings of device identifiers to keys stored at the servers 112. Additionally, the administrator device 108 may communicate with the network switch 102 to configure and/or update mappings of keys to policies stored locally at the network switch 102, configurations for the policies stored locally at the network switch 102, and/or other settings of the network switch 102.

In various implementations, the administrator device 108 and/or additional user devices in communication with the network switch 102 may be implemented using any number of computing devices including, but not limited to, a computer, a laptop, tablet, mobile phone, smart phone, wearable device (e.g., AR/VR headset, smart watch, smart glasses, or the like), smart speaker, vehicle (e.g., automobile), or appliance. Generally, the administrator device 108 may include one or more processors, such as a central processing unit (CPU) and/or graphics processing unit (GPU). The user devices may generally perform operations by executing executable instructions (e.g., software) using the processor(s).

The network 110 may be implemented using one or more of various systems and protocols for communications between computing devices. In various embodiments, the network 110 or various portions of the network 110 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, and the like. Various components of the system 100 may communicate using different network protocols or communications protocols based on location. For example, the one or more servers 112 may be hosted within a cloud computing environment and may communicate with each other using communication and/or network protocols used by the cloud computing environment.

Components of the system 100 shown in FIG. 1 are exemplary and may vary in some embodiments. For example, in some embodiments, the servers 112 may be distributed across multiple computing elements, such that components of the servers 112 communicate with one another through the network 110. Further, in some embodiments, computing resources dedicated to the servers 112 may vary over time based on various factors such as usage of the servers 112.

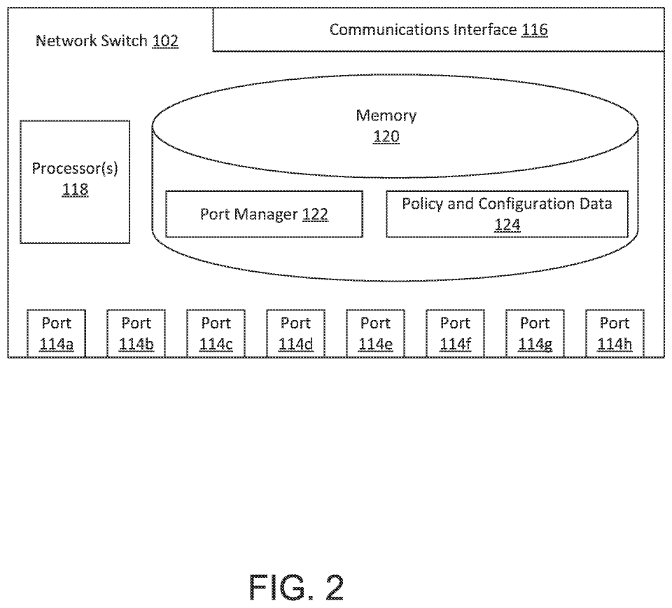

FIG. 2 illustrates a schematic diagram of an example network switch 102, in accordance with various embodiments of the disclosure. The network switch 102 includes a communications interface 116 to connect the network switch 102 to the network 110 and/or additional networks. Network devices may connected to the ports 114a-114h of the network switch. The network devices connected to the ports 114a-114h of the network switch may communicate with the network 110 and/or communicate with one another using, for example, VLANs including sub-groupings of ports of the network switch 102.

The memory 120 may include instructions for various functions of the network switch 102 which, when executed by processor 118, perform various functions of the network switch 102, including automated port provisioning. For example, instructions for implementing a port manager 122 of the network switch 102 may be stored at the memory 120. The memory 120 may further include policy and configuration data 124 utilized, for example, by the port manager 122 in provisioning the ports 114a-114h of the network switch 102.

In various embodiments, the memory 120 may include policy and configuration data 124. Policy and configuration data 124 may include policies or settings that may be applied to the ports 114a-114h to configure the network switch 102. A policy may generally include a port behavior and parameters. Port behavior is generally how a port handles traffic, such as whether the port is a single-endpoint port bridged onto a VLAN or a multi-endpoint trunked port. Parameters may include a VLAN parameter (e.g., which VLAN the port is bridged onto) and/or additional parameters including persistence of the policy. A persistence parameter may be used to determine whether a policy should continue to be applied to a port until changed (e.g., after loss of device connection, shutdown of the network switch 102, power loss, and the like) or whether a different, default policy should be applied to the port after a change in the port state. A policy applied to the port until changed may be referred to as a persistent or inheritable policy. A policy that is not reapplied after a change in port state may be referred to as a non-persistent or non-inheritable policy. Non-persistent policies may be useful for secured devices and/or VLANs, where access to the VLAN is more highly controlled. For example, a VLAN configured for devices transmitting confidential data may be configured using a non-inheritable policy.

In some examples, policy and configuration data 124 may also include a default state for each port 114a-114h of the network switch 102. A default state may include a default port behavior and default VLAN. In some examples, a default state may be applied before any device is connected to a port of the network switch 102. Default states may also be used after a port change and/or event where the current policy applied to the port is non-inheritable or non-persistent. Policy and configuration data 124 may further include a mapping of keys to policies. Keys may correspond to groups of network devices that should be treated a certain way by the network switch 102 (e.g., ports to which the network devices are connected should be configured using the same policy).

In some examples, policy and configuration data 124 may also include cached mappings of device identifiers to keys. Such cached mappings may be stored by the network switch 102 after, for example, receiving a response from the server 112. By caching server 112 responses, the network switch 102 may be able to recover more quickly from network disruptions by using the locally cached mappings of device identifiers to keys instead of querying the server 112 for each key. Further, cached mappings may provide greater availability of devices connected to the network switch 102, as the network switch 102 may be able to operate even where the server 112 becomes unreachable.

The memory may further include instructions which, when executed by the processor 118, implement the port manager 122. The port manager 122 may utilize policy and configuration data 124 to monitor ports 114a-114h and/or configure the ports 114a-114h. When, monitoring the ports 114a-114h, the port manager 122 may utilize a thread actively listening for port changes (e.g., a port coming up, a port going down, a change in the device connected to the port). When the thread detects a port change, it may generate a signal received by the port manager 122, causing the port manager 122 to configure the port. To configure the port, the port manager 122 may obtain a device identifier for the device connected to the port, query a server 112 for a key associated with the device identifier, and utilize policy and configuration data to obtain a policy for the port. In some examples, the port manager 122 may further utilize a default policy specified in the policy and configuration data 124 to configure a port. In some examples, after applying a policy to a port, the port manager 122 may further restart or bounce the port by communicating with a DHCP server to obtain a new IP address for the port.

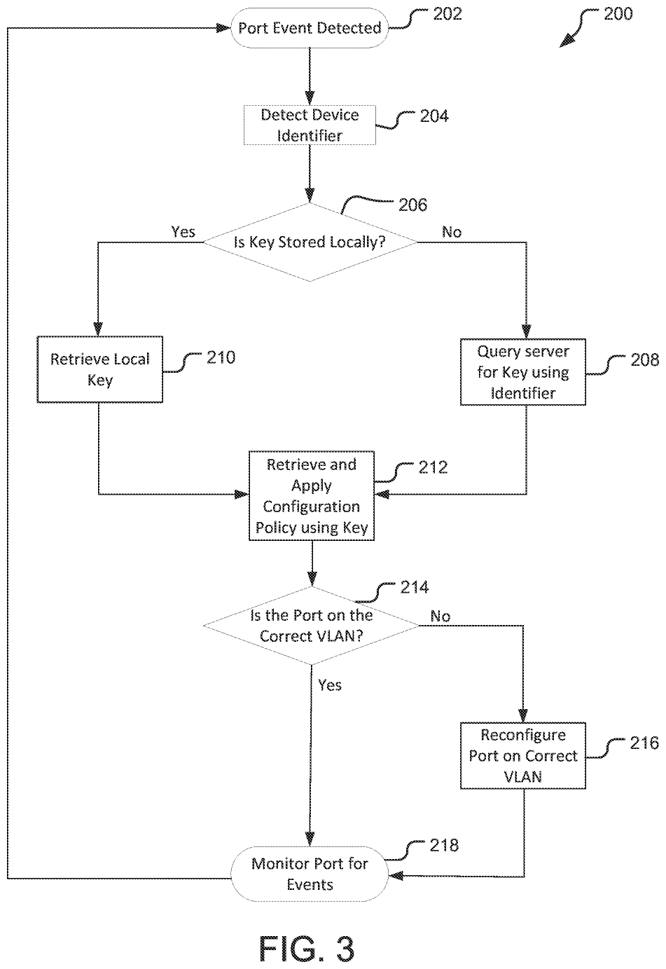

The port manager 122, may, for example, perform example method 200 for configuring a port of a network switch, shown in FIG. 3. At starting block 202, a port event is detected. A port event may, in various examples, be detected by a thread in communication with the port manager 122, where the thread is configured to listen for port changes and generate a signal to the port manager 122 when a change is detected. In some examples, the signal may cause the port manager 122 to pause any pending operations to handle the port event (e.g., by performing the method 200) before resuming any pending operations at the port manager 122.

At block 204, the network switch 102 detects a device identifier for the device connected to the port. The device identifier may be a MAC address broadcasted or otherwise communicated by the device to the network switch 102. The device identifier may also be, in various examples, a manufacturer of the device, a model number or serial number of the device, or other device identifier communicated by the device to the network switch 102.

At decision block 206, the network switch 102 determines whether the key corresponding to the detected device identifier is stored locally. Where the key corresponding to the device identifier is stored locally, the network switch 102 retrieves the local key at block 210. The local key may be stored, for example, with policy and configuration data 124 as a cached response from the server 112.

Where the key corresponding to the detected device identifier is not stored locally, the network switch 102 queries a server 112 for the policy using the detected device identifier at block 208. In various examples, querying a server for the policy may include sending the device identifier to the server 112 and receiving a key from the server 112 corresponding to the device identifier. In some examples, the port manager 122 may cache the response from the server 112, such that the key corresponding to the device identifier is stored locally at the network switch 102 for future use.

At block 212 the network switch 102 retrieves and applies a configuration policy using the key obtained at either block 210 or block 208. The configuration policy generally includes settings for the port of the network switch 102, and tells the network switch how to configure the port for the device. The configuration policy may be retrieved from the locally stored policy and configuration data 124 or may be otherwise stored at the network switch 102. To apply a policy, the port manager 122 may access the policy within the policy and configuration data 124 stored at the network switch 102 to determine the port behavior and VLAN parameter associated with the policy. The port manager 122 may then configure the port in accordance with the port behavior (e.g., as either a single-endpoint port or a trunked multi-endpoint port) and place the port on the VLAN or VLANs specified by the VLAN parameter. In some examples, after placing the port on the correct VLAN, the policy manager 122 may further restart (e.g., bounce) the port. When the port is restarted, the network switch 102 may query another server (e.g., a DHCP server) to obtain a new identifier (e.g., IP address) for the port. Once the port is restarted and a new identifier is obtained, the device connected to the port may be placed on the correct VLAN.

At decision block 214, the network switch 102 determines whether the port is on the correct VLAN (e.g., a VLAN indicated by the policy for the network device). Where the port is on the correct VLAN, the port manager may, in some examples, bounce or restart the port to ensure the device connected to the port is bridged to the correct VLAN. The policy manager 122 may then move to ending block 218 and continue monitoring the port for port events.

Where the port is not on the correct VLAN, the network switch 102 reconfigures the port onto the correct VLAN at block 216. The policy manager 122 may access the policy and configuration data 124 to determine the correct VLAN (or VLANs) for the port based on the policy. In some examples, after placing the port on the correct VLAN, the policy manager 122 may further restart (e.g., bounce) the port. When the port is restarted, the network switch 102 may query another server (e.g., a DHCP server) to obtain a new identifier (e.g., IP address) for the port. Once the port is restarted and a new identifier is obtained, the device connected to the port may be placed on the correct VLAN. The network switch 102 then moves to ending block 218 and continues to monitor the port for port events.

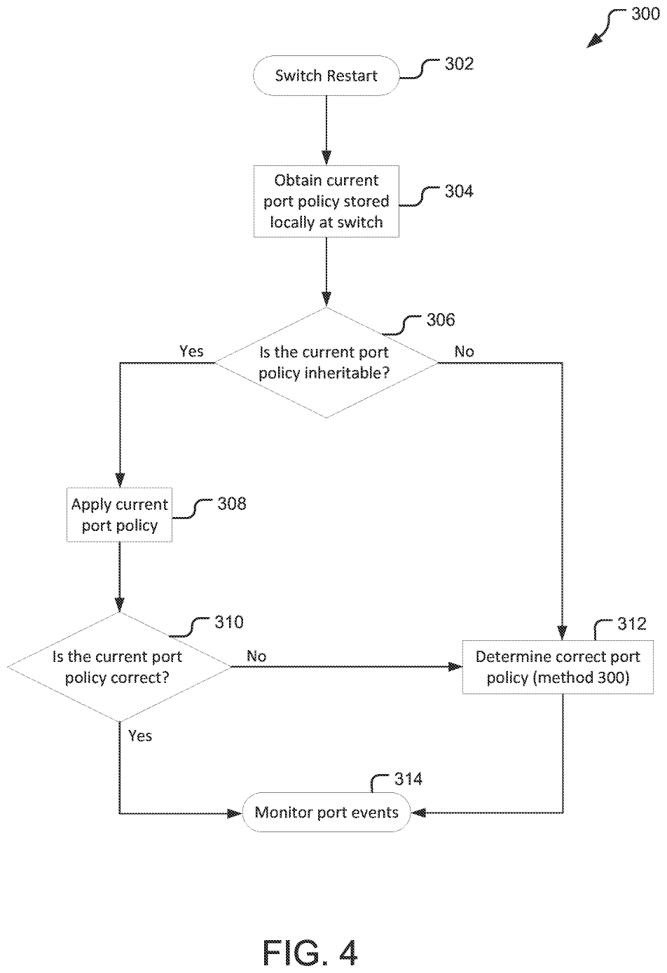

The port manager 122 may further perform example method 300 for configuration of a network switch shown in FIG. 4. At beginning block 302, the network switch 102 restarts. The network switch 102 may restart responsive to, for example, loss of network connection, scheduled restart, power loss, or other manual or automatic restart. In some examples, the method 300 may be performed for each port of a network switch 102 after restart of the network switch 102. The method 300 may further be performed for an individual port of the network switch 102 after restart of the port.

At block 304, the network switch 102 obtains the current policy for a port of the network switch 102, where the current policy is stored locally at the network switch 102. The port manager 122 may access policy and configuration data 124 to determine which policy was most recently applied to the port (e.g., before restart of the port or network switch 102). In some examples, where a most recently applied policy is unavailable for a particular port (e.g., due to an error at the network switch 102), the port manager 122 may select a default policy for the port from the policy and configuration data 124.

At decision block 306, the network switch 102 determines whether the current policy for the port is inheritable. The policy manager 122 may determine if a policy is inheritable (e.g., persistent) by accessing the parameters of a policy in the policy and configuration data 124.

Where the current policy is not inheritable, the network switch 102 may execute the method 200 (moving to start block 202) to determine the current port policy at block 312. In some examples, the port manager 122 may, instead of executing the method 200, apply a default policy to the port and move to block 308.

Where the current policy is inheritable, the network switch 102 applies the current policy at block 308. To apply a policy, the port manager 122 may access the policy within the policy and configuration data 124 stored at the network switch 102 to determine the port behavior and VLAN parameter associated with the policy. The port manager 122 may then configure the port in accordance with the port behavior (e.g., as either a single-endpoint port or a trunked multi-endpoint port) and place the port on the VLAN or VLANs specified by the VLAN parameter.

After applying the current policy at block 308, the network switch 102 determines whether the current port policy is correct at decision block 310. To determine whether the applied port policy is correct, the port manager 122 may determine a device identifier of the network device connected to the port. The port manager 122 may reference policy and configuration data to determine whether a key for the device manager is stored locally (e.g., cached) at the network switch 102. Where the key is not cached locally, the port manager 122 may query a server 112 for the key. Once the key is obtained, the port manager 122 may use the key to determine the correct port policy in the policy and configuration data 124 and may compare that policy to the policy applied to the port.

Where the current port policy is not correct, the network switch 102 executes the method 200 (moving to start block 202) to determine the current port policy at block 312. After the correct port policy is determined using the method 200, the port manager 122 may apply the correct port policy and continue to monitor port events at end block 314.

Where the current port policy is correct, the network switch 102 monitors port events at end block 314. The network switch 102 may monitor port events using a thread in communication with the port manager 122, where the thread listens for port events and generates a signal to the port manager 122 when a port event is detected. In some examples, the signal may cause the port manager 122 to cease any pending operations and handle the port event (e.g., by determining a port policy responsive to the port event) before resuming the pending operations.

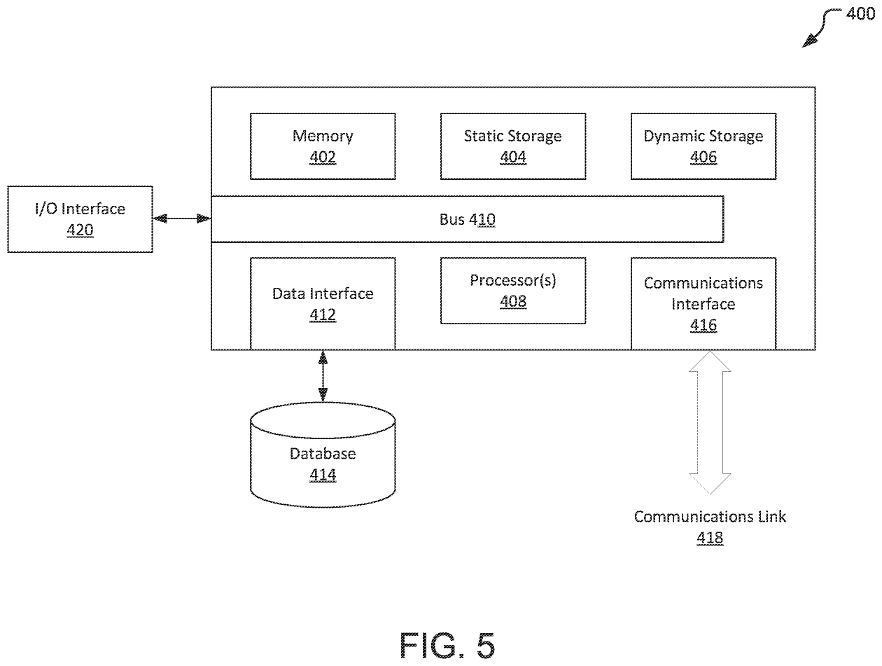

FIG. 5 is a schematic diagram of an example computing system 400 for implementing various embodiments in the examples described herein. For example, a computing system 400 may communicate with, or be used to implement, network switch 102, administrator device 108, server 112, and/or any number of network devices 104a-104g. This disclosure contemplates any suitable number of computing systems 400. A computing system 400 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 400 may include one or more computing systems; be unitary or distributed; span multiple locations; span multiple locations; span multiple machines; span multiple data centers; or reside in a cloud, which may include one or more cloud components in one or more networks.

Computing system 400 includes a bus 410 (e.g., an address bus and a data bus) or other communication mechanism for communicating information, which interconnects subsystems and devices, such as processor 408, memory 402 (e.g., RAM), static storage 404 (e.g., ROM), dynamic storage 406 (e.g., magnetic or optical), communications interface 416 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 420 (e.g., keyboard, keypad, mouse, microphone). In particular embodiments, the computing system 400 may include one or more of any such components.

In particular embodiments, processor 408 includes hardware for executing instructions, such as those making up a computer program. The processor 408 circuitry includes circuitry for performing various processing functions, such as executing specific software for perform specific calculations or tasks. In particular embodiments, I/O interface 420 includes hardware, software, or both, providing one or more interfaces for communication between computing system 400 and one or more I/O devices. Computing system 400 may include one or more of these I/O devices, where appropriate. One or more of these I/O devices may enable communication between a person and computing system 400.

In particular embodiments, communications interface 416 includes hardware, software, or both providing one or more interfaces for communication (such as, for example, packet-based communication) between computing system 400 and one or more other computer systems or one or more networks. One or more memory buses (which may each include an address bus and a data bus) may couple processor 408 to memory 402. Bus 410 may include one or more memory buses, as described below. In particular embodiments, one or more memory management units (MMUs) reside between processor 408 and memory 402 and facilitate accesses to memory 402 requested by processor 408. In particular embodiments, bus 410 includes hardware, software, or both coupling components of computing system 400 to each other.

According to particular embodiments, computing system 400 performs specific operations by processor 408 executing one or more sequences of one or more instructions contained in memory 402. Such instructions may be read into memory 402 from another computer readable/usable medium, such as static storage 404 or dynamic storage 406. In alternative embodiments, hard-wired circuitry may be used in place of or in combination with software instructions. Thus, particular embodiments are not limited to any specific combination of hardware circuitry and/or software. In one embodiment, the term “logic” shall mean any combination of software or hardware that is used to implement all or part of particular embodiments disclosed herein.

The term “computer readable medium” or “computer usable medium” as used herein refers to any medium that participates in providing instructions to processor 408 for execution. Such a medium may take many forms, including but not limited to, nonvolatile media and volatile media. Non-volatile media includes, for example, optical or magnetic disks, such as static storage 404 or dynamic storage 406. Volatile media includes dynamic memory, such as memory 402.

Computing system 400 may transmit and receive messages, data, and instructions, including program, e.g., application code, through communications link 418 and communications interface 416. Received program code may be executed by processor 408 as it is received, and/or stored in static storage 404 or dynamic storage 406, or other storage for later execution. A database 414 may be used to store data accessible by the computing system 400 by way of data interface 412.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. One or more non-transitory computer readable media encoded with instructions which, when executed by one or more processors of a network switch, cause the network switch to:
detect an event associated with a port of the network switch;
determine an identifier for a device associated with the port;
obtain a key based on the identifier, the key associated with a device type of the device;
determine a policy for the port using an association between the key and the policy stored locally at the network switch; and
apply the policy to the port.

2. The one or more non-transitory computer readable media of claim 1, wherein the instructions further cause the network switch to, to obtain the key based on the identifier:
determine whether an association between the identifier and the key is stored locally at the network switch; and
responsive to a determination that the association between the identifier and the key is not stored locally at the network switch, query a server using the identifier to obtain the key.

3. The one or more non-transitory computer readable media of claim 2, wherein the instructions further cause the network switch to:
cache the key obtained from the server locally at the network switch.

4. The one or more non-transitory computer readable media of claim 1, wherein the instructions further cause the network switch to:
monitor the port for further events associated with the port after applying the policy to the port.

5. The one or more non-transitory computer readable media of claim 1, wherein the identifier is a media access control (MAC) address of the device.

6. The one or more non-transitory computer readable media of claim 1, wherein the policy for the port includes a port behavior and a virtual local area network (VLAN) identifier for the port.

7. The one or more non-transitory computer readable media of claim 6, wherein the instructions further cause the network switch to, to apply the policy to the port:
bridge the device to a VLAN specified in the VLAN identifier of the policy.

8. A network switch comprising:
memory storing policy and configuration data for ports of the network switch; and
one or more processors configured to execute instructions causing the one or more processors to:
detect an event associated with one of the ports of the network switch;
determine an identifier for a device associated with the port;
obtain a key based on the identifier, the key associated with a plurality of devices of the same type as the device;
determine a policy for the port using the key and the policy and configuration data; and
apply the policy to the port.

9. The network switch of claim 8, wherein the instructions further cause the one or more processors to, to obtain the key based on the identifier:
determine whether an association between the identifier and the key is stored locally at the memory of the network switch; and
responsive to a determination that the association between the identifier and the key is not stored locally at the network switch, query a server using the identifier to obtain the key.

10. The network switch of claim 9, wherein the instructions further cause the one or more processors to:
cache the key obtained from the server locally at the memory of the network switch.

11. The network switch of claim 8, wherein the instructions further cause the one or more processors to:
monitor the port for further events associated with the port after applying the policy to the port.

12. The network switch of claim 8, wherein the identifier is a media access control (MAC) address of the device.

13. The network switch of claim 8, wherein the policy for the port includes a port behavior and a virtual local area network (VLAN) identifier for the port.

14. The network switch of claim 13, wherein the instructions further cause the one or more processors to, to apply the policy to the port:
bridge the device to a VLAN specified in the VLAN identifier of the policy.

15. A method comprising:
responsive to a restart of a port of a network switch, obtaining, by the network switch, a current policy applied to the port;
determining, based on a parameter associated with the current policy, to apply a default policy to the port;
determining a new policy for the port by:
obtaining a identifier for a device associated with the port,
obtaining a key based on the identifier, the key associated with a plurality of devices of the same type as the device, and
determining the new policy for the port using an association between the key and the new policy stored locally at the network switch; and
applying the new policy to the port.

16. The method of claim 15, wherein the parameter associated with the current policy specifies that the policy is non-inheritable after a change to the port.

17. The method of claim 15, wherein the current policy applied to the port is stored locally at the network switch.

18. The method of claim 15, wherein the default policy is stored locally at the network switch.

19. The method of claim 15, wherein obtaining the key based on the identifier comprises querying, by the network switch, a server storing an association between the identifier and the key.

20. The method of claim 19, further comprising:
caching the key obtained from the server locally at the network switch.
